(19) United States
(12) Patent Application Publication
(10) Pub. No.: US 2010/0034439 A1
(43) Pub. Date: Feb. 11, 2010

(54) MEDICAL IMAGE PROCESSING APPARATUS AND MEDICAL IMAGE PROCESSING METHOD

(75) Inventor: Mieko Asano, Kanagawa (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/507,178

(22) Filed: Jul. 22, 2009

(30) Foreign Application Priority Data
Aug. 8, 2008 (JP) 2008-206292

(51) Int. Cl. G06K 9/00; G06K 9/36

(52) U.S. Cl. 382/128; 382/285

(57) ABSTRACT

A projected image generating unit generates a projected image of a two-dimensional image that expresses three-dimensional information, based on three-dimensional data stored in an original image storing unit. A position information storage unit records therein three-dimensional position information of a target pixel that has been detected by the projected image generating unit and the coordinates of the target pixel within the projected image, while keeping them in correspondence with each other. A user inputs a position of a specified point within the projected image by using an input unit. By referring to the position information storage unit, a position obtaining unit obtains three-dimensional position information of the specified point. An area extracting unit extracts a three-dimensional image of a target area containing the specified point, based on the three-dimensional position information of the specified point that has been obtained by the position obtaining unit.

### CROSS-REFERENCE TO RELATED APPLICATIONS

This application is based upon and claims the benefit of priority from the prior Japanese Patent Application No. 2008-206292, filed on Aug. 8, 2008; the entire contents of which are incorporated herein by reference.

### BACKGROUND OF THE INVENTION

1. Field of the Invention

The present invention relates to a medical image processing apparatus and a medical image processing method.

2. Description of the Related Art

Diagnostic imaging techniques have conventionally known. According to these diagnostic imaging techniques, three-dimensional volume data is generated from a plurality of cross-sectional images of the inside of the human body that are obtained by using an imaging device such as a computed tomography (CT) apparatus or a Magnetic Resonance Imaging (MRI) apparatus so that a diagnosis can be made based on an image reconstructed from the generated three-dimensional volume data.

Examples of methods for reconstructing a three-dimensional image from three-dimensional volume data include a Maximum Intensity Projection (MIP) method where the maximum concentration value among the pixels positioned on a straight line extending along the viewing direction is projected and displayed and a Minimum Intensity Projection (MinIP) method where the minimum concentration value is projected and displayed. When these methods are used, it is difficult to grasp the front-back relationship in a three-dimensional manner unless a plurality of images are used.

Further, according to another diagnostic imaging technique that is also known, image data of a desired diagnosis target region (e.g., an organ or a blood vessel) that is to be examined is extracted from three-dimensional volume data and displayed on a display device such as a display monitor, so that pathological conditions of the affected region can be determined. Pixel values of organs and blood vessels are not uniform. Especially, extremities and outline portions of organs and blood vessels have low intensity values and are, in many situations, hidden by other organs or blood vessels. Thus, it has been difficult to selectively display the desired diagnosis target region.

Another method has been proposed by which a user (e.g., a doctor or a medical technologist) who operates an apparatus specifies the center of a cross section that is orthogonal to the lengthwise direction of a diagnosis target region (i.e., a tubular tissue), out of a two-dimensional cross-sectional image of the inside of the human body being displayed and thus specifies an extraction starting point and an extraction ending point (see, for example, Japanese Patent No. 3984202). It is, however, difficult to specify a narrow blood vessel, because a cross-sectional image thereof has low intensity values and is not clear. In addition, tubular tissues extend not only in a horizontal direction and a vertical direction, but in many different directions. Thus, it is difficult to understand the continuity of each tissue based on one cross section. It is therefore difficult to find and specify the extraction staring point and the extraction ending point. Further, in some situations, in cross-sectional images other than those of cross sections that are orthogonal to the lengthwise direction, parts of the tubular tissue may be hidden behind other organs or blood vessels and are not visible. Consequently, it is difficult for the user to find and specify the desired blood vessel out of a mere two-dimensional cross-sectional image of the inside of the human body.

According to the conventional techniques described above, it is difficult to understand the continuity of the entirety of each region in the human body based on the cross-sectional image. Thus, the user is required to select the desired diagnosis target region while figuring out the positional relationship in three-dimensions. As a result, it is difficult for the user to selectively have the desired diagnosis target displayed.

### SUMMARY OF THE INVENTION

According to one aspect of the present invention, a medical image processing apparatus that extracts a target area in a specified diagnosis region by using three-dimensional data obtained by capturing an image of a subject, the apparatus includes a display unit that displays an image; a projected image generating unit that detects, with respect to each of projected pixels on a projected plane, a target pixel having a pixel value that satisfies a specific condition from a series of pixels corresponding to the projected pixel obtained by scanning the three-dimensional data in a direction perpendicular to the projected plane, and generates a projected image by specifying the pixel value of each target pixel as a pixel value of a corresponding one of the projected pixels; a position information storage unit that correspondingly stores position information of each of target pixels expressed in the three-dimensional data and position information of each of the projected pixels within the projected image; an input unit that causes the display unit to display the projected image and receives an input of a position information of a specified point within the projected image of the diagnosis region; a position obtaining unit that obtains position information expressed in the three-dimensional data corresponding to the position information of the specified point, by referring to the position information storage unit, when the input unit receives the input of the specified point; and an area extracting unit that extracts the target area in the diagnosis region from the three-dimensional data, by using the position information of the specified point expressed in the three-dimensional data, wherein the display unit displays the target area extracted by the area extracting unit.

According to another aspect of the present invention, a medical image processing method for extracting a target area in a specified diagnosis region by using three-dimensional data obtained by capturing an image of a subject, the method includes detecting, with respect to each of projected pixels on a projected plane perpendicular to a line-of-sight direction, a target pixel having a pixel value that satisfies a specific condition from a series of pixels corresponding to the projected pixel obtained by scanning the three-dimensional data along the line-of-sight direction, and generating a projected image by specifying the pixel value of each target pixel as a pixel value of a corresponding one of the projected pixels; storing correspondingly, into a position information storage unit, position information of each of target pixels expressed in the three-dimensional data and position information of each of the projected pixels within the projected image; presenting the projected image to a user and receiving, from an outside source, an input of a position information of a specified point within the projected image of the diagnosis region; obtaining position information expressed in the three-dimensional data corresponding to the position information of the specified point, by referring to the position information storage unit, when the specified point is input from the outside source; extracting the target area in the diagnosis target region from the three-dimensional data, by using the position information of the specified point expressed in the three-dimensional data; and presenting the extracted target area to the user.

### BRIEF DESCRIPTION OF THE DRAWINGS

FIG. 1 is a diagram of an image processing apparatus according to an embodiment of the present invention;

FIG. 2 is a flowchart of a process performed by the image processing apparatus according to the embodiment;

FIGS. 3A, 3B, and 3C are drawings for explaining examples of an intensity value projected image generated by a projected image generating unit;

FIGS. 4A, 4B, and 4C are drawings for explaining a method for obtaining three-dimensional position information of a specified point;

FIGS. 5A, 5B, and 5C are drawings for explaining an example in which there are a plurality of pixels each having a maximum intensity in a line-of-sight direction;

FIGS. 6A, 6B, and 6C are drawings for explaining an example in which a maximum intensity projected image is generated by rotating a line-of-sight direction; and

FIGS. 7A and 7B are drawings for explaining a process that is performed in the case where no diagnosis target region is present in a specified point.

### DETAILED DESCRIPTION OF THE INVENTION

Exemplary embodiments of a medical image processing apparatus according to the present invention will be explained in detail, with reference to the accompanying drawings. Some of the constituent elements that are mutually the same will be referred to by using the same reference characters, and duplicate explanation thereof will be omitted.

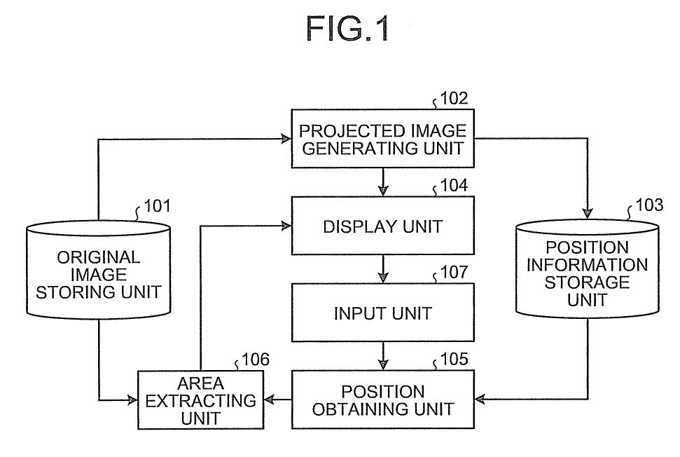

As shown in FIG. 1, a medical image processing apparatus includes an original image (three-dimensional volume data) storing unit 101, a projected image generating unit 102, a position information storage unit 103, a display unit 104, an input unit 107, a position obtaining unit 105, and an area extracting unit 106.

The original image storing unit 101 stores therein three-dimensional data that is image data having a three-dimensional coordinate space that has been obtained by an imaging device (not shown) through a process of capturing images of the inside of a subject (i.e., the inside of the human body). The imaging device captures the images while scanning the inside of the human body at predetermined intervals in a predetermined direction and obtains a plurality of two-dimensional cross-sectional images. A collection of the two-dimensional cross-sectional images will be referred to as three-dimensional data. The imaging device may be, for example, a computed tomography (CT) scanner or a Magnetic Resonance Imaging (MRI) apparatus. The original image storing unit 101 may be provided in a memory or may be configured with a recording medium such as a hard disk device or a Read-Only Memory (ROM), as long as the original image storing unit 101 is able to store therein the captured image data.

The projected image generating unit 102 generates a projected image that is a two-dimensional image representing three-dimensional information based on the three-dimensional data stored in the original image storing unit 101. The projected image is generated by using the intensity value of one or more pixels that satisfy a condition (hereinafter, the “target pixels”) and have been selected out of a series of intensity values of pixels positioned on a straight line in a predetermined direction in the three-dimensional data (hereinafter, the “line-of-sight direction”) that has been specified by the user. The details of the method for generating the projected image will be explained later.

As for the condition used for selecting the target pixels, for example, one or more pixels each having a pixel value of which the intensity value is the maximum value or the minimum value among one series of intensity values may be used as the target pixels. Alternatively, another arrangement is acceptable in which one or more pixels each of which satisfies a condition are selected as the target pixels, by using, among one series of intensity values, intensity values of pixels that are positioned in a specified area expressed with three-dimensional coordinates. The method for selecting the target pixels may be determined depending on the characteristics of the diagnosis target and/or the properties of the imaging device.

When the projected image is generated based on the pixel values of the target pixels, information (hereinafter “three-dimensional position information”) that indicates the position of each of the target pixels within the three-dimensional coordinate space is also obtained at the same time. In the case where there are two or more target pixels each of which satisfies the condition mentioned above, a plurality of pieces of position information may be obtained.

The position information storage unit 103 records therein the pieces of three-dimensional position information of the target pixels (e.g., the pixels each having the maximum intensity value among the one series of pixel values in the line-of-sight direction) and the coordinates of the targets pixels within the projected image, while keeping them in correspondence with one another.

The display unit 104 is a display device such as a display monitor. The display unit 104 displays, for example, a three-dimensional image that has been captured by the imaging device, the projected image that has been generated by the projected image generating unit 102, a specified point that has been input by the user through the input unit 107, and an image of a target area that has been extracted by the area extracting unit 106.

The input unit 107 receives various input operations from outside sources, such as a key operation, a mouse operation, a touch pen operation, or the like, that has been performed by a user (e.g., a doctor or a medical technologist) who operates the medical image processing apparatus. By referring to the projected image displayed by the display unit 104, the user is able to input a position of a point (hereinafter, the “specified point”) within the projected image by using the input unit 107, the point being selected out of a diagnosis target region (e.g., an organ or a blood vessel) from which the user wishes to have an area extracted (which is called “segmentation”). In other words, two-dimensional position information (i.e., the coordinates) of the specified point within the projected image is input. Another arrangement is acceptable in which the input unit 107 is configured so that the user performs an input operation from the outside thereof via a network.

When the user has input the specified point through the input unit 107, the position obtaining unit 105 obtains three-dimensional position information of the specified point by referring to the position information storage unit 103 based on the coordinates of the specified point within the projected image.

Based on the three-dimensional position information of the specified point that has been obtained by the position obtaining unit 105, the area extracting unit 106 extracts three-dimensional image data of a target area that is the target of an extracting process, out of the diagnosis target region containing the specified point.

Next, a method used by the area extracting unit 106 to extract the target area that has been selected by the user will be explained. In the following sections, as an example, a method for extracting a specified blood vessel when the user has specified a point in the blood vessel as the specified point will be explained.

Based on the three-dimensional data, a plurality of cross-sectional images near the specified point is generated, the cross-sectional images being obtained by slicing the three-dimensional volume data at mutually different cross-sectional planes. This process is performed for the purpose of detecting a starting point used in a process of tracking the blood vessel specified by the specified point, out of each of the plurality of cross-sectional images.

Each of the pixel values in the generated cross-sectional images is binarized through a process using a threshold value. The threshold value may be determined based on the intensity value of the specified point or may be given separately. After that, a circular figure is detected from each of the cross-sectional images that have been binarized. The circular figure may be detected by using, for example, any of connected-component detecting methods that are often used during image processing so that a level of similarity to a circle can be determined by using the number of connected components and the size of a circumscribed rectangle. Alternatively, it is acceptable to use another method by which the circular figure is detected by matching circle templates with the entire image. It is acceptable to use any other method as long as it is possible to detect a target that is similar to a circle and can be assumed to be a cross-sectional image of a blood vessel positioned near the three-dimensional position of the specified point. The center of the detected circle will be used as the starting point.

Subsequently, a cross-sectional image of a neighborhood of the center of the detected circle is generated. In a similar manner, a circular figure is also detected out of the generated cross-section image. When the circle detected first is referred to as a circle 1, whereas the circle detected second is referred to as a circle 2, it is judged whether these circles are actual circles by judging whether an overlapping area between the circle 1 and the circle 2 is equal to or larger than α % and whether the distance between the coordinates of the respective centers is equal to or shorter than β. The blood vessel is tracked in the direction from the center of the circle 1 to the center of the circle 2. The example described here is an example used for extracting a blood vessel area. It is acceptable to use any other methods that have already been proposed. The shape used in the approximation process does not necessarily have to be a circle. It is acceptable to use any other shape as long as it represents a cross-sectional shape of the blood vessel. Further, the diagnosis target region from which an area is extracted does not necessarily have to be a blood vessel, either.

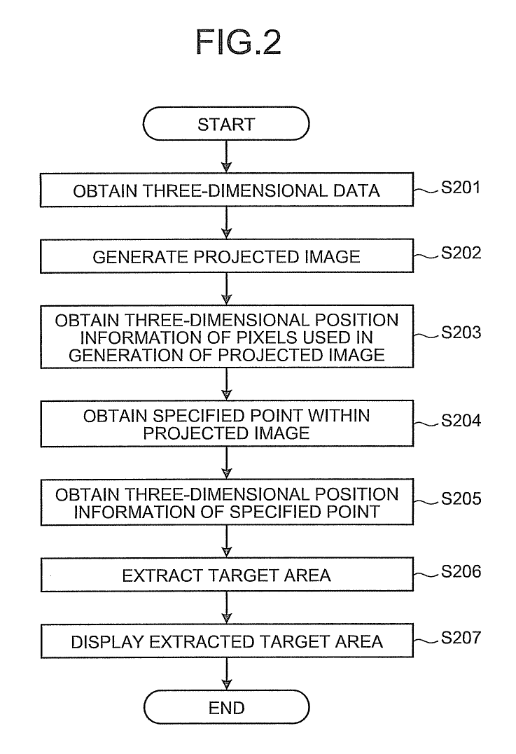

First, in FIG. 2, three-dimensional data of an image of the inside of the human body that has been captured by an imaging device is obtained and stored into the original image storing unit 101 (step S201). The projected image generating unit 102 generates a projected image that uses a predetermined direction as a line-of-sight direction, based on the three-dimensional data stored in the original image storing unit 101 (step S202). The line-of-sight direction is specified by a user through the input unit 107. In this situation, another arrangement is acceptable in which the user specifies a projected plane. Subsequently, three-dimensional position information of the pixels of which the intensity values have been used for generating the projected image is stored into the position information storage unit 103 (step S203).

The projected image is displayed on the display unit 104. A specified point is input by the user (i.e., a doctor or a medical technologist in the present example) who operates the medical image processing apparatus, through an operation performed on the input unit 107. The coordinates of the specified point within the projected image is obtained (step S204). Another arrangement is acceptable in which, when the projected image is displayed on the display unit 104, a cross-sectional image generated from the three-dimensional data and/or results of various processes and/or a message or the like that prompts the user to input a specified point are displayed and presented to the user at the same time.

After that, with reference to the position information storage unit 103 based on the coordinates of the input specified point within the projected image, three-dimensional position information of the specified point is obtained (step S205).

Based on the three-dimensional position information of the specified point that has been obtained by the position obtaining unit 105, the area extracting unit 106 extracts a three-dimensional image of a target area in a diagnosis target region containing the specified point, from the three-dimensional data stored in the original image storing unit 101 (step S206). The target area that has been extracted is displayed on the display unit 104 (step S207). To display the extracted target area, it is acceptable to use a method by which a three-dimensional image of the target area is generated and displayed, or another method by which a three-dimensional image of the target area is generated together with an image of another diagnosis target region so that the target area is highlighted in a color that is different from the color in which said another diagnosis target region is displayed. It is acceptable to use any other various methods to present the extracted target area to the user.

Next, a method used by the projected image generating unit 102 to generate the projected image based on the three-dimensional data will be explained.

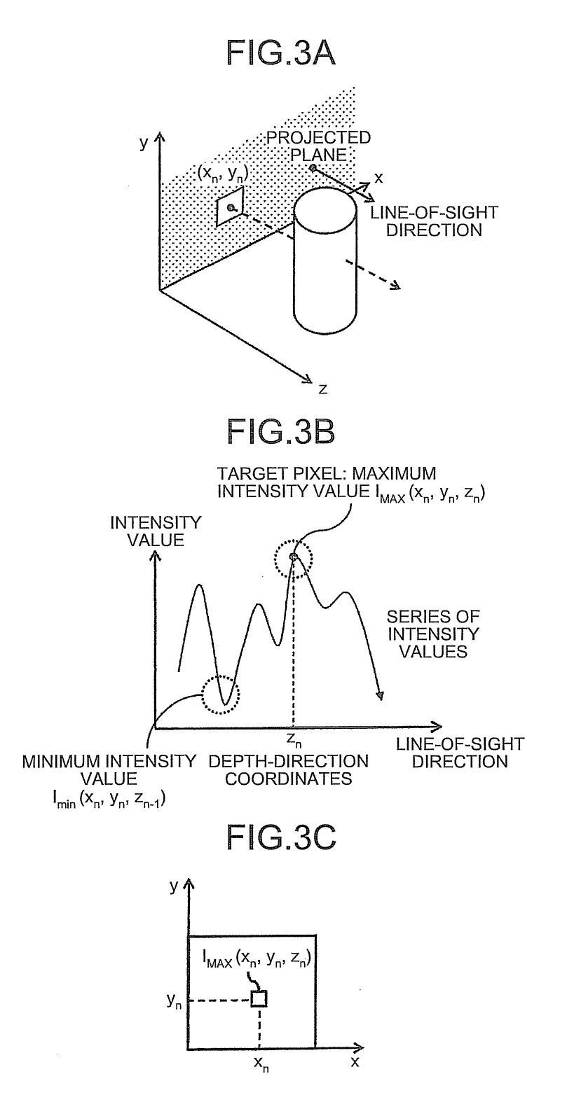

FIGS. 3A, 3B, and 3C are drawings for explaining the method used by the projected image generating unit 102 to generate the projected image (at step S202). With reference to FIGS. 3A, 3B, and 3C, an example will be explained in which, of a series of pixel values in the line-of-sight direction, one or more pixels each of which satisfies the condition where the intensity value thereof is the maximum value are selected as the target pixels, so that the projected image is generated by using the pixel value of the target pixels as the pixel value of the projected image. The line-of-sight direction is specified based on a direction that has been input by the user through the input unit 107.

FIG. 3A is a drawing of an example of the three-dimensional data. The x-y plane is a projected plane on which the projected image is generated. The direction (i.e., the z-axis direction) that is perpendicular to the projected plane is the line-of-sight direction.

Shown in FIG. 3B is a series of intensity values that is, in the three-dimensional data, positioned on a straight line extending in the line-of-sight direction from a point (xₙ, yₙ) on the projected plane and that has been extracted. When z=zₙ is satisfied, an intensity value I_{MAX} (xₙ, yₙ, zₙ) is the maximum value. The pixel that satisfies z=zₙ is selected as the target pixel corresponding to the pixel positioned at the point (xₙ, yₙ) on the projected plane.

As shown in FIG. 3C, the projected image generating unit 102 generates the projected image by writing the intensity value I_{MAX} (xₙ, yₙ, zₙ) of the obtained target pixel into the pixel value of the pixel positioned at the point (xₙ, yₙ) within the projected image. In this situation, the coordinates (xₙ, yₙ, zₙ) of the target pixel are stored into the position information storage unit 103 as the three-dimensional position information. The three-dimensional position information does not necessarily have to be indicated with a coordinate series based on the line-of-sight direction. It is acceptable to use any other type of information as long as it is possible to indicate the position of the target pixel within the three-dimensional data. In that situation, it is necessary to store the position information with respect to the projected image and the three-dimensional position information, while keeping them in correspondence with each other. Also, in the case where there are two or more target pixels among one series of pixel values in the line-of-sight direction, a plurality of pieces of three-dimensional position information may be stored.

In the case where the target pixel is obtained by using a condition where the pixel has the minimum intensity value among the series of intensity values, the pixel having the pixel value Iₘᵢₙ (xₙ, yₙ, zₙ₋₁) shown in FIG. 3B is selected as the target pixel, so that the projected image is generated by writing the pixel value Iₘᵢₙ (xₙ, yₙ, zₙ₋₁) of the selected target pixel into the pixel value of the pixel positioned at the point (xₙ, yₙ) within the projected image shown in FIG. 3C. In this situation, the coordinates (xₙ, yₙ, zₙ₋₁) of the target pixel is stored into the position information storage unit 103 as the three-dimensional position information.

Next, a method for obtaining the three-dimensional position information of the specified point, based on the coordinates of the input specified point within the projected image will be explained.

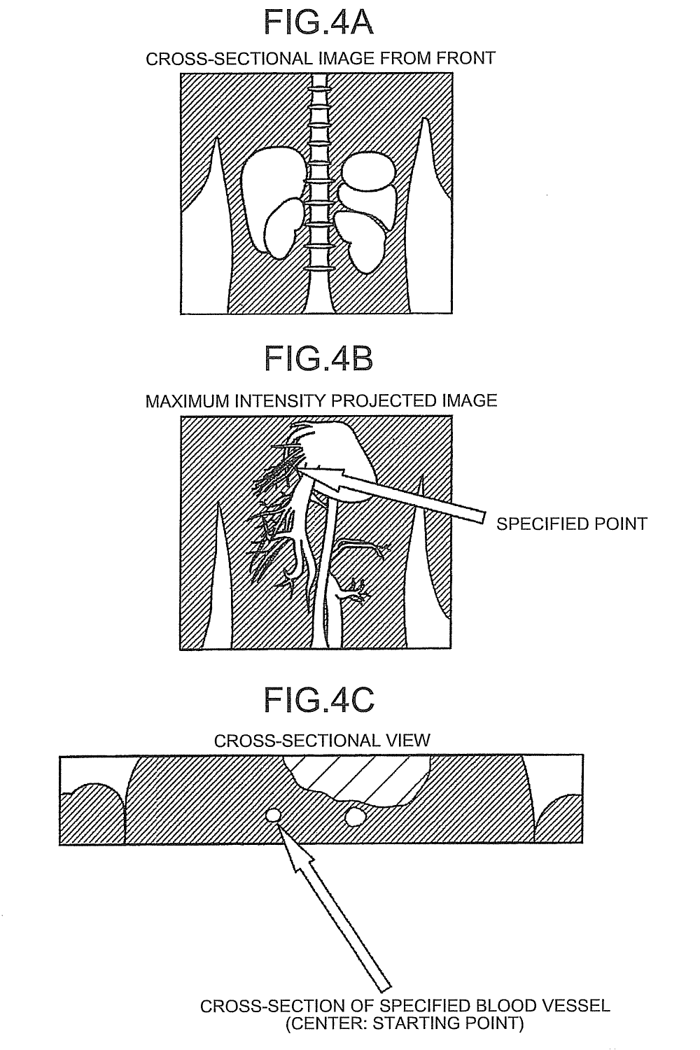

FIG. 4A is a drawing of an example of a cross-sectional image viewed from the front of the human body. FIG. 4B is a drawing of an example of a projected image obtained by using a plane that faces the front of the human body as a projected plane. FIG. 4C is a drawing of an example of a cross-sectional image viewed from above the human body.

The projected image shown in the drawing is displayed on the display unit 104, so that the user specifies a point within the projected image as a specified point, by using the input unit 107. In the present example, the user has specified the point indicated by an end of the arrow shown in FIG. 4B as the specified point. By referring to the position information storage unit 103, the position obtaining unit 105 obtains three-dimensional position information of the specified point corresponding to the coordinates of the specified point within the projected image, the specified point having been input by the user. Based on the three-dimensional position information, the area extracting unit 106 detects a cross section of the blood vessel that serves as a target, out of such a cross-sectional image of a neighborhood in the three-dimensional data that contains the specified point. The white circular area indicated by the end of the arrow in FIG. 4C is the cross section of the blood vessel that has been detected. The area extracting unit 106 extracts the blood vessel by using the center of the cross-sectional circle as a starting point.

Next, a process that is performed in the case where a specified point has been specified in a situation where there are two or more target pixels on a straight line extending in the line-of-sight direction will be explained.

First, a position expressed by a set of coordinates (x, y) of the specified point within the projected image is obtained. After that, three-dimensional position information corresponding to the set of coordinates (x, y) is obtained. In this situation, in the case where there is only one corresponding set of coordinates in the three-dimensional data, the set of coordinates is used as the coordinates with which the starting point is detected. In the case where there are two or more corresponding sets of coordinates, levels of reliability are compared based on the three-dimensional position information of the pixels that are positioned in a neighborhood of the specified point within the projected image, so that one of the sets of coordinates to be used is determined based on the result of the comparing process. For example, the one of the sets of coordinates to be used may be determined by using the following method: The three-dimensional position information of the pixels contained in a neighborhood of the specified point having a size of w×w is compared with the three-dimensional position information of the specified point. When the deviation of any one of the sets of coordinates is smaller than a threshold value, the set of coordinates is judged to be reliable and determined as the set of coordinates to be used.

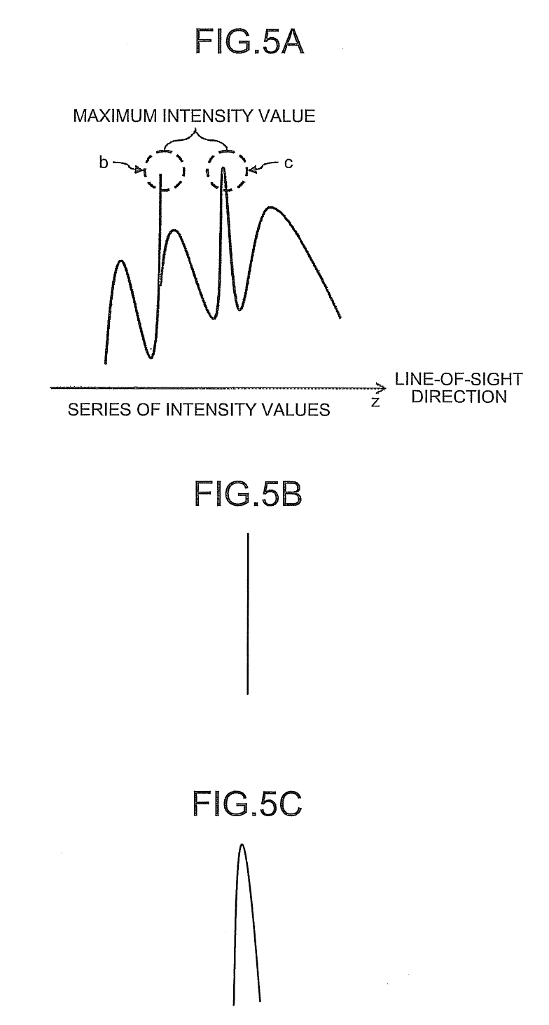

FIGS. 5A, 5B, and 5C are drawings for explaining an example with a series of intensity values in the case where there are two pixels (i.e., two sets of coordinates) each having the maximum intensity value on one straight line that extends in the line-of-sight direction. FIGS. 5A, 5B, and 5C are drawings for explaining an example in which the set of coordinates to be used as the starting point is determined by using a method different from the method explained above.

FIG. 5A is a drawing of an example of a series of intensity values on a straight line that extends in a line-of-sight direction. On the straight line, there are a plurality of pixels each of which has the maximum intensity value and can serve as a target pixel. These target pixels will be referred to as “b” and “c”. FIG. 5B is a drawing for explaining changes in the intensity values in a neighborhood of the target pixel “b”. FIG. 5C is a drawing for explaining changes in the intensity values in a neighborhood of the target pixel “c”.

A changing ratio of the intensity values is calculated based on the distribution of intensity values in the neighborhood of each of the target pixels or the changes in the intensity values of a predetermined number of pixels that are positioned before and after each of the target pixels on the straight line extending in the line-of-sight direction. As a result, it is possible to determine that the target pixel “b”, which has an intensity value that is prominently larger than the surrounding pixel values, is a noise, whereas the target pixel “c” is a point in the diagnosis target region.

Another arrangement is acceptable in which, without performing the judging process explained above, a plurality of pixels corresponding to the coordinates of the specified point are displayed in such a manner that it is easy for the user to recognize each of the pixels (e.g., the pixels are displayed in mutually different colors) so that the user is prompted to select one of the pixels. The pixels are presented to the user by displaying a cross-sectional image or a three-dimensional image that goes through each of the pixels, at the same time as the projected image is displayed on the display unit 104. The user is then prompted to specify which pixel is to be specified as a specified point. Any other various methods may be used to present the pixels to the user.

Next, a method for specifying a specified point will be explained, in correspondence with a situation where the blood vessel from which the user wishes to extract an area is hidden behind another blood vessel or the like, and the user is not able to specify the blood vessel out of the projected image.

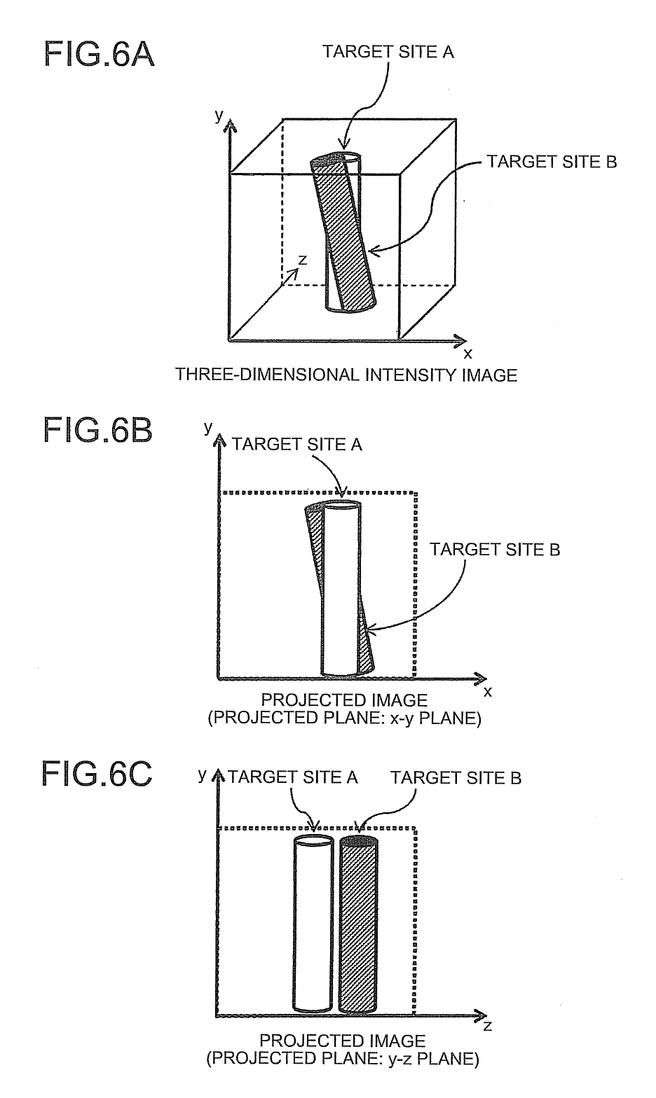

FIGS. 6A, 6B, and 6C are drawings for explaining an example in which blood vessels having mutually different intensity values overlap each other, and some parts thereof are not visible in a projected image when being viewed from a line-of-sight direction (i.e., from the front of the human body).

FIG. 6A is a drawing for explaining a situation in which, in the three-dimensional data, a blood vessel having a smaller intensity value overlaps another blood vessel having a larger intensity value. A target region A denotes the blood vessel having the larger intensity value. A target region B denotes the blood vessel having the smaller intensity value.

FIG. 6B is a drawing of a projected image generated by using an x-y plane as a projected plane, based on the three-dimensional data shown in FIG. 6A, by using the maximum value intensity projecting method. In this situation, because the target region A has an intensity value higher than the intensity value of the target region B, if the user specifies an overlapped portion in the projected image, an area in the target region A will be extracted. Thus, even if the user wishes to select the target region B, it is difficult for the user to select the target region B out of the projected image as shown in FIG. 6B.

FIG. 6C is a drawing of a projected image generated by using a y-z plane as a projected plane, based on the three-dimensional data shown in FIG. 6A, by using the maximum value intensity projecting method. It can be observed that the target region B, which is hidden in FIG. 6B, is now visible in FIG. 6C. It is easy for the user to select the target region B out of the projected image shown in FIG. 6C.

As explained above, an arrangement is acceptable in which the projected image generating unit 102 generates projected images by rotating the target region by a number of degrees at a time, the target region otherwise being hidden when being viewed from only one line-of-sight direction. With this arrangement, it is possible to generate the projected images while changing the line-of-sight direction so that the hidden target region becomes visible.

Next, a process performed by the position obtaining unit 105 will be explained in correspondence with the case where no blood vessel or the like that serves as a target of the detection process is present in the position expressed in the three-dimensional data corresponding to an input specified point within the projected image.

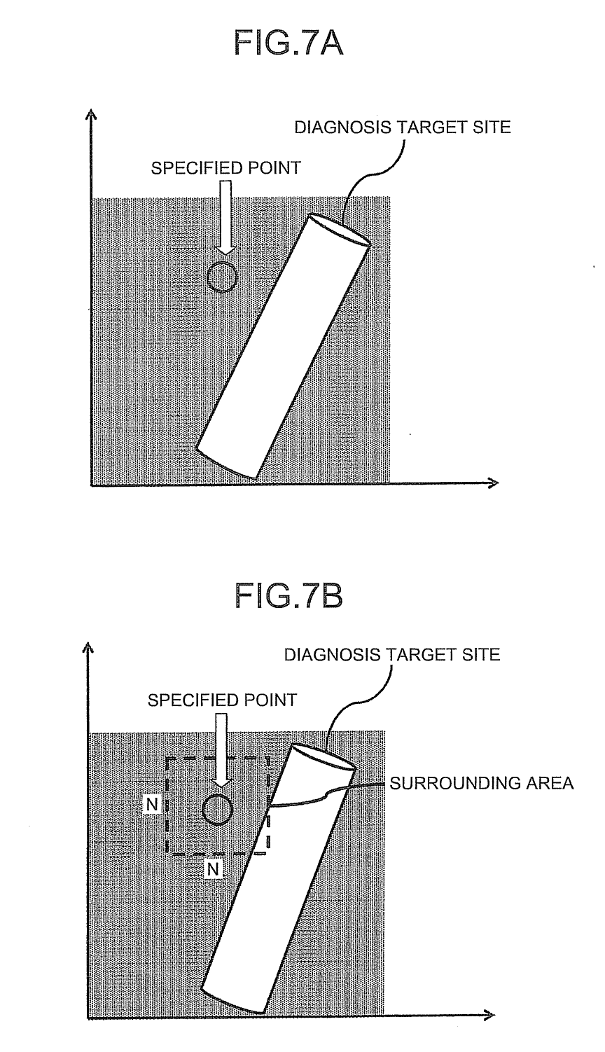

FIGS. 7A and 7B are drawings for explaining a process that is performed in the case where no diagnosis target region (e.g., a blood vessel or an organ) is present in the specified point that has been input by the user.

FIG. 7A is a drawing of an example of a projected image in which the specified point that has been specified by the user does not indicate any diagnosis target region (e.g., a blood vessel) from which an area can be extracted. The position obtaining unit 105 refers to the position information storage unit 103 based on the coordinates of the specified point within the projected image. In this situation, it is judged whether the obtained intensity value is an intensity value of a diagnosis target region. In the case where the intensity value of the specified point that has been specified is apparently lower than the intensity value of a portion that can serve as a diagnosis target region such as a blood vessel, it is judged that the specified point does not indicate any diagnosis target region. In the case where the specified point does not indicate any diagnosis target region, the pixel values in a neighborhood of the specified point within the projected image that has a size of N×N are referred to. Of the pixels within the N×N area that have been referred to, the three-dimensional position information of the pixel having a intensity value of the highest frequency is used as the coordinates of the specified point.

Also, in the case where no diagnosis target region is present in the specified point that has been input by the user, the projected image is reconstructed by rotating an image that is used in the process of generating the projected image by a number of degrees at a time. An arrangement is acceptable in which, when a blood vessel becomes visible within a post-rotation projected image in a position that is near the position selected by the user out of a pre-rotation projected image, the position of the blood vessel is assumed to be a specified point, so that the user can confirm the assumption. Another arrangement is acceptable in which the medical image processing apparatus automatically determines a specified point, without using the selection made by the user.

When the medical image processing according to the present embodiment is used, the user is able to select the diagnosis target region from which the user wishes to extract an area, while understanding the continuity of the entirety of each of the tissues, out of the projected image that has been generated.

In the description of the embodiment above, the example in which the user specifies only one specified point is explained. However, another arrangement is acceptable in which the user specifies a starting point and an ending point within a diagnosis target region by using the input unit 107, so that an area that connects these two points to each other is extracted as a target area. Yet another arrangement is acceptable in which the user specifies the size of an area to be extracted, by using the input unit 107.

In the description of the embodiment above, the line-of-region direction is input by the user; however, another arrangement is acceptable in which the projected image generating unit 102 generates a projected image by using a predetermined plane as the projected plane without using an input from the user. For example, a direction in which the human body can be viewed from the front thereof may be specified, in advance, as the line-of-sight direction.

In the description of the present embodiment above, the example is explained in which the diagnosis target region serving as the target from which an area is extracted is a blood vessel and in which the maximum intensity value in the line-of-sight direction is used as the condition under which the projected image is generated. However, the present invention is not limited to the exemplary embodiments described above. It is possible to apply various modifications to the present invention without changing the gist thereof.

As explained above, according to the present invention, the medical image processing apparatus that uses the original image is able to easily obtain the coordinates of the position within the three-dimensional space and simplify the process of specifying the diagnosis target region. In particular, the medical image processing apparatus is suitable for extracting an area from a tubular diagnosis target region such as a blood vessel. The desired three-dimensional image is read from the original image storing unit 101. To perform the input operation, the user may select the desired three-dimensional image out of a data list showing stored data that is displayed on a screen for displaying images, i.e., the display monitor of the display unit 104. Alternatively, the images may be obtained from a process of directly scanning the human body.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A medical image processing apparatus that extracts a target area in a specified diagnosis region by using three-dimensional data obtained by capturing an image of a subject, the apparatus comprising:
a display unit that displays an image;
a projected image generating unit that detects, with respect to each of projected pixels on a projected plane, a target pixel having a pixel value that satisfies a specific condition from a series of pixels corresponding to the projected pixel obtained by scanning the three-dimensional data in a direction perpendicular to the projected plane, and generates a projected image by specifying the pixel value of each target pixel as a pixel value of a corresponding one of the projected pixels;
a position information storage unit that correspondingly stores position information of each of target pixels expressed in the three-dimensional data and position information of each of the projected pixels within the projected image;
an input unit that causes the display unit to display the projected image and receives an input of position information of a specified point within the projected image of the diagnosis region;
a position obtaining unit that obtains position information expressed in the three-dimensional data corresponding to the position information of the specified point, by referring to the position information storage unit, when the input unit receives the input of the specified point; and
an area extracting unit that extracts the target area in the diagnosis region from the three-dimensional data, by using the position information of the specified point expressed in the three-dimensional data, wherein
the display unit displays the target area extracted by the area extracting unit.

2. The apparatus according to claim 1, wherein the position information storage unit correspondingly stores the position information within the projected image and the position information of each of two or more target pixels expressed in the three-dimensional data, when there are two or more target pixels among the one series of pixels.

3. The apparatus according to claim 2, wherein
the position obtaining unit judges whether the diagnosis region is present in a position information expressed in the three-dimensional data that corresponds to the position information of the specified point within the projected image, and
the position obtaining unit detects a pixel contained in the diagnosis region based on pixel values of pixels in a neighborhood of the specified point within the projected image, and uses the detected pixel as the specified point, when the position obtaining unit judges that the diagnosis target region is not present.

4. The apparatus according to claim 3, wherein
the position obtaining unit judges whether each of the target pixels is a pixel contained in the diagnosis region, and obtains the position information thereof expressed in the three-dimensional data for any of the target pixels judged to be a pixel contained in the diagnosis region, when there are a plurality of pieces of position information expressed in the three-dimensional data that correspond to the position information of the specified point within the projected image.

5. The apparatus according to claim 4, wherein the position obtaining unit judges whether each of the target pixels is a pixel contained in the diagnosis region, based on a changing ratio of pixel values in a neighborhood of the target pixels expressed in the three-dimensional data.

6. The apparatus according to claim 1, wherein the projected image generating unit generates projected image by using the pixel value of each target pixel detected from the series of pixels based on the condition where an intensity value thereof is maximum or minimum.

7. The apparatus according to claim 1, wherein the projected image generating unit generates a plurality of projected images that respectively correspond to mutually different projected planes.

8. The apparatus according to claim 1, wherein
the input unit receives inputs of two position information, each position information corresponds to one of two specified points in the projected image of the diagnosis region, the two specified points being requested to be extracted,
the position obtaining unit obtains position information of each of the two specified points expressed in the three-dimensional data, and
the area extracting unit extracts an area that connects the two specified points to each other as the target area.

9. A medical image processing method for extracting a target area in a specified diagnosis region by using three-dimensional data obtained by capturing an image of a subject, the method comprising:
detecting, with respect to each of projected pixels on a projected plane perpendicular to a line-of-sight direction, a target pixel having a pixel value that satisfies a specific condition from a series of pixels corresponding to the projected pixel obtained by scanning the three-dimensional data along the line-of-sight direction, and generating a projected image by specifying the pixel value of each target pixel as a pixel value of a corresponding one of the projected pixels;
storing correspondingly, into a position information storage unit, position information of each of target pixels expressed in the three-dimensional data and position information of each of the projected pixels within the projected image;
presenting the projected image to a user and receiving, from an outside source, an input of position information of a specified point within the projected image of the diagnosis region;
obtaining position information expressed in the three-dimensional data corresponding to the position information of the specified point, by referring to the position information storage unit, when the specified point is input from the outside source;
extracting the target area in the diagnosis target region from the three-dimensional data, by using the position information of the specified point expressed in the three-dimensional data; and
presenting the extracted target area to the user.
